(19) United States
(12) Patent Application Publication
(10) Pub. No.: US 2009/0184056 A1
(43) Pub. Date: Jul. 23, 2009

(54) Method of removing dissolved iron in aqueous systems

(76) Inventors: Kevin W. Smith, Houston, TX (US); Harry D. Smith, JR., Montgomery, TX (US)

Correspondence Address: William L. Krayer, 1771 Helen Drive, Pittsburgh, PA, 15216, US

(21) Appl. No.: 12/321,534

(22) Filed: Jan. 22, 2009

Related U.S. Application Data
(63) Continuation-in-part of application No. 12/009,915, filed on Jan. 23, 2008.

(51) Int. Cl. B01D 21/01

(52) U.S. Cl. 210/712; 210/722

(57) ABSTRACT

Oilfield completion, drilling, produced, flowback, and workover fluids containing iron are treated to remove the iron by passing them through a cavitation device together with an oxidizing agent and with the addition of lime. The cavitation device intimately mixes the oxidizing agent with the fluid while increasing the temperature of the fluid, thus promoting the oxidation reaction. Lime contributes to an increase in pH while promoting the formation of floc. Ferric hydrate and other solids or colloidal iron are removed in a filter capable of removing particles as small as 0.5 micron. The system may be enhanced by the addition of a bed of activated carbon capable of catalyzing the oxidation reaction.

### RELATED APPLICATION

This is a continuation-in-part of our application Ser. No. 12/009,915 filed Jan. 23, 2008.

### TECHNICAL FIELD

Dissolved iron is removed from an aqueous solution by passing the solution through a cavitation device while feeding an oxidizing agent into the solution, feeding calcium oxide into the solution, mixing and heating the solution in the cavitation device to oxidize ferrous iron to ferric iron, optionally increasing the pH, and separating the solid iron oxide formed in the solution in a filter. The process is particularly useful for removing iron from oilfield completion, drilling, and workover fluids

### BACKGROUND OF THE INVENTION

Iron dissolved in various kinds of aqueous solutions has caused many undesirable effects, and its removal has long been a vexing problem. As applied to workover and completion fluids used in hydrocarbon recovery, sometimes called clear completion brines, used in oil recovery, the background of the problem has been well described by Qu et al in U.S. Pat. No. 7,144,512:
“High density brines (completion brines) have been widely used in well completion and workover operations in oilfields in the past several decades. The completion brines are salt solutions typically having fluid densities ranging from about 8.4 ppg (pounds per gallon) to about 20 ppg. Depending on the density desired, a completion brine can be a one salt solution (e.g. NaCl, NaBr, CaCl2, CaBr2, ZnBr2 or formate salt in water), a two salt solution (e.g. CaCl2/CaBr2 or ZnBr2/CaBr2), or a three salt solution (e.g. ZnBr2/CaBr2/CaCl2). The composition of the brines determines the fluid properties such as pH, density, etc. Depending on the economics, a fluid can be used in a well and then purchased back to be cleaned and reused later.
At the conclusion of any completion or workover project, a substantial volume of ‘contaminated’ or unneeded completion/workover fluid typically remains. Such fluids may be contaminated with any or all of the following: water, drilling mud, formation materials, rust, scale, pipe dope, and viscosifiers and bridging agents used for fluid-loss-control pills. Depending on their composition and level of contamination, these fluids may or may not have further practical or economic value. If it is deemed that the fluids have future use potential, they may be reclaimed. Conversely, if they are determined to have no further use, they must be disposed of in an environmentally responsible way.
The benefits derived from the use of solids-free fluids, and especially high-density brines, for completion and workover operations have been extensively documented in the literature. Unfortunately, the costs associated with the initial purchase and subsequent disposal of such brines has been a hindrance to their universal acceptance especially since the “use once and dispose” means of disposal is neither prudent nor economically sound.
Because of the relatively high cost and limited worldwide natural mineral resources available for producing medium- and high-density completion/workover fluids, it is essential that their used fluids be reclaimed. The reconditioned fluids must meet the same specifications as those of ‘new’ or ‘clean’ fluids. With respect to completion/workover fluids, the term ‘clean’ denotes not only the absence of suspended solids but also the absence of undesirable colloidal or soluble species which are capable of undergoing adverse reactions with formation, formation fluids or other completion fluids to produce formation-damaging insoluble substances.
There are many known methods for removing contaminates from a brine solution. One approach is to remove suspended solids by filtration. Simple filtration processes, wherein the brine is filtered through a plate and frame type filter press with the use of a filter aid such as diatomaceous earth and then through a cartridge polishing filter, are effective to remove solid contamination but they have no effect on removing other types of contamination such as colloidal or soluble species. This is the case since colloidally dispersed and soluble contaminants cannot be removed by filtration without first treating the fluid to change the chemical and/or physical properties of the contaminants. The treatments required to salvage the fluid depend on the nature of the contaminants incorporated and their chemical and physical properties.”

In the field of hydrocarbon recovery, almost all used clear completion fluids, and also many drilling fluids, produced fluids and flowback fluids generally contain iron, which has historically been extremely difficult to remove in the process of cleaning and preserving the fluids for reuse. Iron is generally in the form of FeO, which is soluble in the low pH common in completion fluids. Dissolved iron in the form of FeO cannot be filtered unless it is oxidized to a higher oxidative state. Simply raising the pH means the useful zinc and calcium bromide salts will also precipitate. The fluid incorporates dissolved oxygen from the air with normal pumping and handling, which converts the iron to Fe₂O₃ in the form of a 0.5 micron colloidal suspension, but the quantity of oxygen dissolved in this manner is seldom enough. Such small colloidal suspensions are very difficult to filter. Leaving 0.5 micron solids downhole is a problem since the formation is essentially a porous medium that cannot be backwashed. Everyone knows about iron, but until now no one has developed a practical solution for iron removal. One can add oxygen scavengers to try to keep the iron in solution, but that masks the problem and is never a permanent solution. One cannot add enough oxygen scavenger to prevent the iron from precipitating in the formation. There is simply too much oxygen. In addition, iron oxidation is a relatively slow process. One can filter a fluid today and it will be crystal clear, but tomorrow one will start seeing rust or Fe₂O₃ dropping out of solution. Thus, the problem has been that the ubiquitous iron is usually in solution in a used clear completion fluid, but it will damage the formation if it is not removed; removal without diminishing the other components of the fluid, or undertaking an enormous expense, has been elusive.

Various methods of oxidizing iron in water are reviewed by Schlafer et al in U.S. Pat. No. 5,725,759. See also Maree, U.S. Pat. No. 6,419,834. Hydrogen peroxide is one of several oxidizing agents proposed to oxidize iron in well servicing fluids to a higher oxidation state; the oxide is stabilized at a higher pH, and the fluid is then filtered, in Darlington et al 4,465,598. Particles as small as 0.1 micrometer are said to be filtered from oil and gas well fluids by Abrams et al in U.S. Pat. No. 4,436,635.

As none of these processes has achieved commercial success, there is a need in the industry for a practical way to prepare used completion, workover, and drilling fluids, and other produced and flowback fluids for reuse, including removing iron from them.

### SUMMARY OF THE INVENTION

The invention involves passing the iron-containing completion, drilling, produced, backflow, or workover solution, in the presence of added oxidizing agent and added calcium oxide, through a cavitation device, followed by filtration using a filter capable of removing particles as small as 0.5 micrometers. Concentration of dissolved oxygen or other oxidizing agent is maintained within the cavitation device at levels of at least 2 mg./L, and the temperature within the cavitation device is maintained at least at 40° C. Generally, however, higher temperatures mean greater reactivity between the oxygen of the air, or from another source, and the ferrous iron in the solution. The elevated temperature promotes iron oxidation. The pH can be increased by the addition of lime alone or lime (CaO) together with alkali metal hydroxides, to at least 2.5.

Our invention involves the treatment not only of the high density brines described by Qu et al in the above-quoted '512 patent, but also fluids commonly called “produced water” or “Produced fluids.” Produced fluids in oilfield parlance are derived mainly from the earth and arrive at the earth's surface as a result of one or more actions by the operators while preparing for or actually extracting hydrocarbons; they can be mixed with the hydrocarbons or with the oilfield fluids, or can be substantially unmixed, or treated to be separated. The term “flowback,” or, sometimes, “backflow,” generally includes all types of fluids arriving at the earth's surface, but typically is comprised of mostly fluids injected into a well by the operators. Our invention is applicable to and beneficial for all produced and backflow fluids as well as drilling, workover, and completion fluids; the loose definitions of all such fluids may overlap somewhat. We use the term “used oilfield fluids” to include any or all such fluids including fluids from the earth which have literally not yet been “used” by the operators.

The cavitation device is operated so that oxygen or other oxidizing agent and the calcium oxide are thoroughly mixed and/or dissolved in the fluid and the temperature of the fluid is increased to the point at which the ferrous iron is converted to ferric iron, forming a colloidal-size precipitate of Fe₂O₃, which may be in hydroxide form —Fe₂O₃.xH₂O. Colloidal iron is typically about 1 micron in size. Residence time in the cavitation device may be enhanced by recycling. The solution, now containing colloidal solids and larger particulates due to the action of the CaO, is removed from the cavitation device and the solids are separated by a filter, preferably capable of removing particles as small as 0.5 micrometers. Floc formation and filtration are enhanced by including lime (CaO) in the brine.

The solution may be monitored for iron content before entering the cavitation device, and the introduction of oxygen controlled to supply the amount required to oxidize the iron or slightly more. The oxygen may be introduced in the form of air, oxygen, ozone, or a chemical oxidizing agent such as hydrogen peroxide, chlorine-containing bleaches, various carbamates, or any other suitable oxidizing agent. Generally also it may be expected that air may enter the system through seals and/or the ordinary action of centrifugal or other pumps that move the fluid into the cavitation device and elsewhere in the system; the pumps may introduce air into the fluid in amounts approaching or even in excess of the 2 milligrams per liter usually sufficient to oxidize the iron present.

An unconventional source of oxygen may be found on some drilling sites using nitrogen obtained by non-cryogenic separation process from air. The main purpose of this technique is to make an enriched nitrogen source for use in drilling in order to reduce the amount of oxygen in the drilling area. The main byproduct of this process, which usually involves membrane separation, is an oxygen-rich gas. This gas, containing a much higher percentage of oxygen than air, can be used in our invention anywhere we inject air or other oxidizing agents. The oxygen-rich byproduct is called a waste gas in Michael U.S. Pat. No. 5,749,422. See also Michael U.S. Pat. No. 5,388.

When processing used completion and workover fluids, we do not require filtration before passing the fluid into the cavitation device, since its operation is unaffected by undissolved solids which may be found in used workover or completion fluids After passing through the cavitation device, a coarse filter may be used to remove larger particles before iron is removed in a microfilter. In processing used drilling fluids it may also be desirable to filter or screen the fluid before passing the fluid into the cavitation device.

The cavitation device has a distinct advantage in the common situation where polymeric viscosifiers, or other polymers, are present in the fluid to be treated for iron removal. Water-soluble polymers of almost all varieties are notorious for their tendency to plug filters, and this is especially true where the pore size of the filter is small. Subjecting the viscosity-enhancing polymers to the cavitation process and its accompanying temperature increase, however, will physically destroy the polymer molecules and render their remnants filterable without plugging the filters. The heat generated within the cavitation device during its normal operation also assists in reducing the detrimental effects of polymers via breakdown and/or viscosity reduction. The cavitation device also enables intimate mixing of calcium oxide with the colloids and solid forms of iron oxide, bringing about a very efficient floc formation useful in filtration and other types of separation.

Our invention benefits from the additional use of certain types of activated carbon which have been found to rapidly decompose peroxides or otherwise catalytically enhance the oxidation rate of the iron species in the liquid. The liquid is beneficially contacted with the activated carbon immediately downstream from the cavitation device, but may be used anywhere in the system to enhance the reaction of a peroxide with the iron species in the liquid.

### BRIEF DESCRIPTION OF THE DRAWINGS

FIGS. 1a and 1b are views of slightly different cavitation devices useful in our invention.

FIG. 2 is a flow sheet showing the use of a cavitation device for treatment of a used oilfield fluid to remove iron.

FIG. 3 is a flow sheet which includes an activated carbon unit.

FIG. 3a is a flow sheet variation employing two cavitation devices—one to mix the oxygen into the fluid and the other to mix the calcium oxide into it.

FIG. 4 is a flow sheet to illustrate the experiment of Example 1.

FIG. 5 illustrates mixing air with the fluid in the cavitation device.

### DETAILED DESCRIPTION OF THE INVENTION

We use a cavitation device to increase the temperature of the used oilfield fluid while also mixing it with an oxidizing agent to oxidize the iron and, at the same time, calcium oxide (lime) to make a readily filterable floc by combining the lime with the colloids and other solid forms of iron oxide. A cavitation device heats a solution within it by generating shock waves within the solution and also by friction within the device. The term “cavitation” derives from pockets or cavities which are filled by shock waves of fluid. The heat, as well as the mixing, enhances the reactions.

We use the term “cavitation device” to mean and include any device which will impart thermal energy to flowing liquid by causing bubbles or pockets of partial vacuum to form within the liquid it processes, the bubbles or pockets of partial vacuum being quickly imploded and filled by the flowing liquid. The bubbles or pockets of partial vacuum have also been described as areas within the liquid which have reached the vapor pressure of the liquid. The turbulence and/or impact, which may be called a shock wave, caused by the implosion imparts thermal energy to the liquid, which, in the case of water, may readily reach boiling temperatures. The bubbles or pockets of partial vacuum are typically created by flowing the liquid through narrow passages which present side depressions, cavities, pockets, apertures, or dead-end holes to the flowing liquid; hence the term “cavitation effect” is frequently applied. Steam or vapor generated in the cavitation device can be separated from the remaining, now concentrated, water and/or other liquid which frequently will include significant quantities of solids small enough to pass through the reactor. We prefer to use cavitation devices made by Hydro Dynamics, Inc., of Rome, Ga., most preferably the device described in U.S. Pat. Nos. 5,385,298, 5,957,122, 5,188,090, and particularly 6,627,784, all of which are incorporated herein by reference in their entireties. In recent years, Hydro Dynamics, Inc. has adopted the trademark “Shockwave Power Reactor” for its cavitation devices, and we use the term SPR herein to describe the products of this company and other cavitation devices that can be used in our invention. The term “cavitation device” includes not only all the devices described in the above itemized patents 5,385,298, 5,957,122 6,627,784 and 5,188,090 but also any of the devices described by Sajewski in U.S. Pat. Nos. 5,183,513, 5,184,576, and 5,239,948, Wyszomirski in U.S. Pat. No. 3,198,191, Selivanov in U.S. Pat. No. 6,016,798, Thoma in U.S. Pat. Nos. 7,089,886, 6,976,486, 6,959,669, 6,910,448, and 6,823,820, Crosta et al in U.S. Pat. No. 6,595,759, Giebeler et al in U.S. Pat. Nos. 5,931,153 and 6,164,274, Huffman in U.S. Pat. No. 5,419,306, Archibald et al in U.S. Pat. No. 6,596,178 and other similar devices which employ a shearing effect between two close surfaces, at least one of which is moving, such as a rotor, and/or at least one of which has cavities of various designs in its surface as explained above. The cavitation process also causes intimate mixing of the fluid constituents as they pass through the device, and additional heating is provided as a result of friction generated as the fluid and the rotor move within the housing.

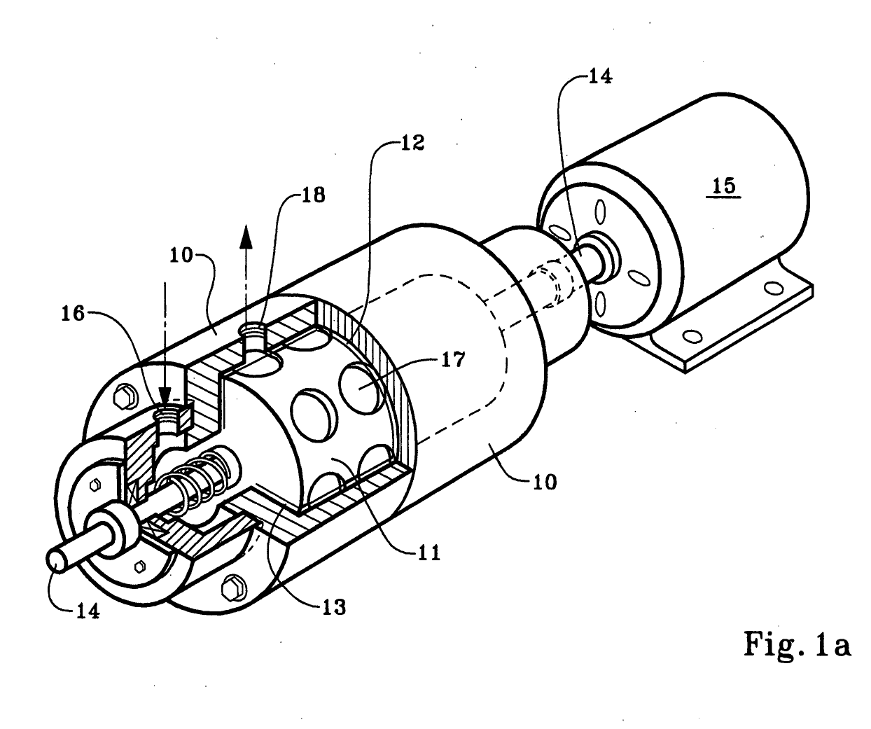

FIGS. 1a and 1b show two slightly different variations, and views, of a cavitation device, sometimes known as a cavitation pump, or a cavitation regenerator, and sometimes referred to herein as an SPR, which we use in our invention to regenerate solutions comprising heavy brine components.

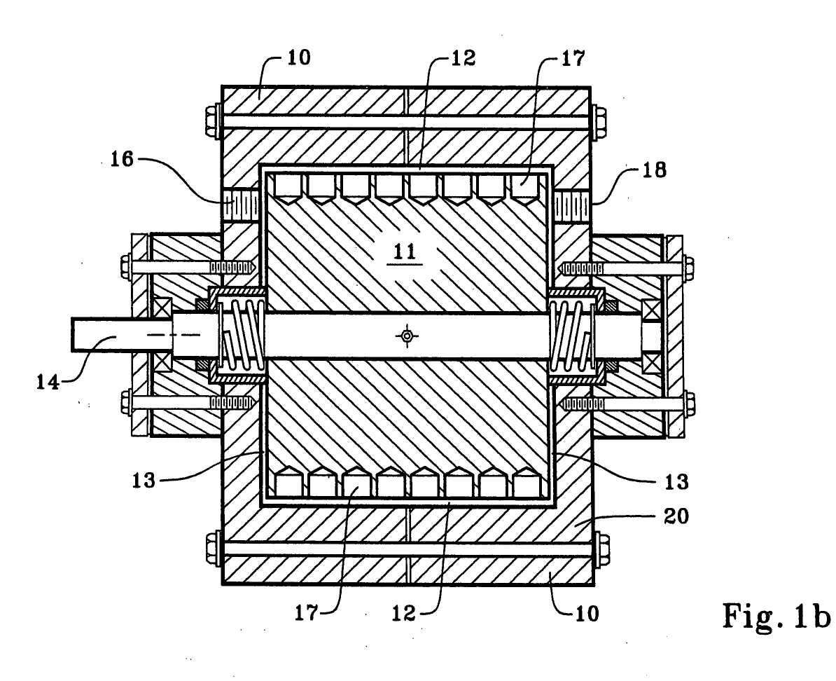

FIGS. 1a and 1b are adapted from FIGS. 1 and 2 of Griggs U.S. Pat. No. 5,188,090, which is incorporated herein by reference along with related U.S. Pat. Nos. 5,385,298, 5,957,122, and 6,627,784. As explained in the 5,188,090 patent and elsewhere in the referenced patents, liquid is heated and mixed in the device without the use of a heat transfer surface, thus avoiding the usual scaling problems common to boilers and distillation apparatus.

A housing 10 in FIGS. 1a and 1b encloses cylindrical rotor 11 leaving only a small clearance 12 around its curved surface and clearance 13 at the ends. The rotor 11 is mounted on a shaft 14 turned by motor 15. Cavities 17 are drilled or otherwise cut into the surface of rotor 11. As explained in the Griggs patents, other irregularities, such as shallow lips around the cavities 17, may be placed on the surface of the rotor 11. Some of the cavities 17 may be drilled at an angle other than perpendicular to the surface of rotor 11—for example, at a 15 degree angle. Liquid (fluid)—in the case of the present invention, a used workover, drilling, or completion fluid containing iron,—is introduced through port 16 under pressure and enters clearances 13 and 12. As the fluid passes from port 16 to clearance 13 to clearance 12 and out exit 18, areas of vacuum are generated and heat is generated within the fluid from its own turbulence, expansion and compression (shock waves). As explained at column 2 lines 61 et seq in the 5,188,090 patent, “(T)he depth, diameter and orientation of (the cavities) may be adjusted in dimension to optimize efficiency and effectiveness of (the cavitation device) for heating various fluids, and to optimize operation, efficiency, and effectiveness . . . with respect to particular fluid temperatures, pressures and flow rates, as they relate to rotational speed of (the rotor 11).” Smaller or larger clearances may be provided (col. 3, lines 9-14). Also the interior surface of the housing 10 may be smooth with no irregularities or may be serrated, feature holes or bores or other irregularities as desired to increase efficiency and effectiveness for particular fluids, flow rates and rotational speeds of the rotor 11. (col. 3, lines 23-29) Rotational velocity may be on the order of 5000 rpm (col 4 line 13). The diameter of the exhaust ports 18 may be varied also depending on the fluid treated. Pressure at entrance port 16 may be 75 psi, for example, and the temperature at exit port 18 may be as high as 300° F. Thus the heavy brine components containing solution may be flashed or otherwise treated in and/or following the cavitation device to remove excess water as steam or water vapor. Note that the position of exit port 18 is somewhat different in FIGS. 1a and 1b; likewise the position of entrance port 16 differs in the two versions and may also be varied to achieve different effects in the flow pattern within the SPR.

Another variation which can lend versatility to the SPR is to design the opposing surfaces of housing 10 and rotor 11 to be somewhat conical, and to provide a means for adjusting the position of the rotor within the housing so as to increase or decrease the width of the clearance 12. This can allow for different sizes of solids present in the fluid, to reduce the shearing effect if desired (by increasing the width of clearance 12), to vary the velocity of the rotor as a function of the fluid's viscosity, or for any other reason.

Operation of the SPR (cavitation device) is as follows. A shearing stress is created in the solution as it passes into the narrow clearance 12 between the rotor 11 and the housing 10. This shearing stress causes an increase in temperature. The solution quickly encounters the cavities 17 in the rotor 11, and tends to fill the cavities, but the centrifugal force of the rotation tends to throw the fluid back out of the cavity, which creates a vacuum. The vacuum in the cavities 17 draws fluid back into them, and accordingly “shock waves” are formed as the cavities are constantly filled, emptied and filled again. Small bubbles, some of them microscopic, are formed and imploded, even when no air or other gas has been added to the fluid. All of this stress on the fluid mixes the constituents of the fluid and generates heat which increases the temperature of the fluid dramatically. The design of the SPR ensures that, since the bubble collapse and most of the other stress takes place in the cavities, little or no erosion of the working surfaces of the rotor 11 takes place, and virtually all of the heat generated remains within the fluid.

Temperatures within the cavitation device—of the rotor 11, the housing 10, and the fluid within the clearance spaces 12 between the rotor and the housing—remain substantially constant after the process is begun and while the feed rate and other variables are maintained at the desired values. There is no outside heat source; it is the mechanical energy of the spinning rotor—to some extent friction, as well as the above described cavitation effect—that is converted to heat taken up by the solution and soon removed along with the solution when it is passes through exit 18. The rotor and housing indeed tend to be lower in temperature than the liquid in clearances 12 and 13. There is little danger of scale formation even with high concentrations of heavy brine components in the solution being processed.

Any solids present in the solution, having dimensions small enough to pass through the clearances 12 and 13 may pass through the SPR unchanged. This may be taken into account when using the reconstituted solution for oil well purposes. Subjecting water-soluble polymers that may be present in the solution to the localized cavitation process and heating will tend to reduce their viscosity-imparting abilities, break them down, shear them, or otherwise completely destroy them; in any case they will not be likely to foul or plug the filters set up to remove precipitated iron compounds. Where lime is added to the fluid in dry form, as it may be in the present invention, the cavitation device not only can handle it as long as it remains in particle form, but is admirably suited to assure that it will be dispersed and reduced to an extremely small size within a short time.

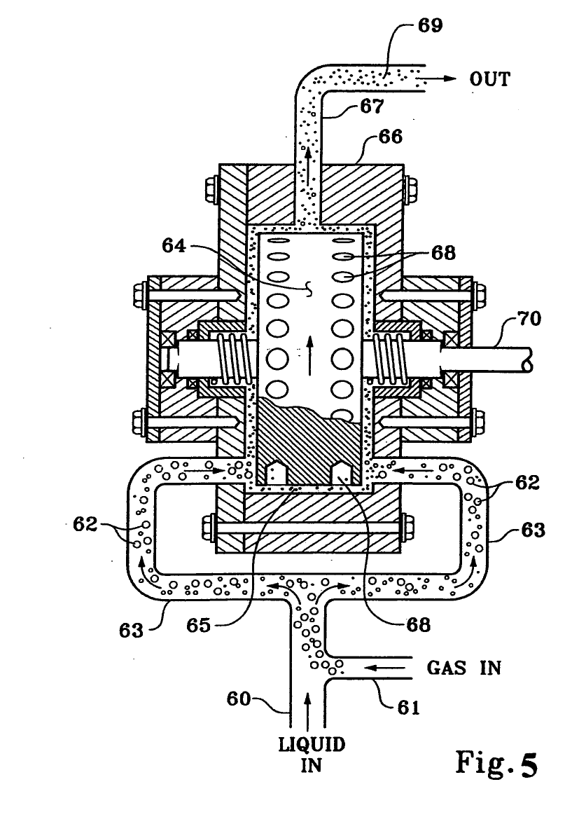

Hudson et al U.S. Pat. No. 6,627,784, one of the patents incorporated by reference above, describes the introduction of a gas to a fluid just prior to entering a cavitation device. Gas such as air or oxygen is injected into the conduit leading to port 16, as depicted herein in FIGS. 1a and 1b, and especially illustrated in FIG. 5 hereof. There may be more than one port 16, not all of which need necessarily contain both liquid and gas. As explained in the Hudson et al patent, the cavitation process, acting on the crude mixture of liquid and gas—for example, air—breaks down the air bubbles into a large number of very small bubbles, thus greatly increasing the surface area of a given volume of bubbles and greatly increasing the likelihood of contact by the air or oxygen with a species susceptible to oxidation. The air or oxygen may be dissolved in the liquid. Hudson et al describe specifically the oxidation of sodium sulfide in black liquor, a byproduct of cooking wood chips.

Referring now to FIG. 2, the iron-containing used oilfield fluid enters cavitation device 30 through conduit 31, being propelled by a pump not shown. An oxidizing agent is introduced to conduit 31 through line 32. The oxidizing agent may be oxygen, air, a solution of hydrogen peroxide, sodium or ammonium persulfate, or any of various carbamates known as oxidizing agents, or any other convenient oxidizing agent such as a chlorine-containing bleach. The oxidizing agent immediately begins mixing with the fluid and the mixing effect is greatly enhanced within the cavitation device as explained above, bringing about intimate contact between the oxidizing agent and the iron species in the fluid under elevated temperatures due to the cavitation effect. If the oxidizing agent is a gas, such as air or oxygen, bubbles formed in the conduit 31 will immediately be dispersed and greatly divided into microbubbles, to the point of dissolution, similar to the effect described in the above cited Hudson et al patent 6,627,784. The dispersion and intimate contact of the oxidizing agent with the iron species causes oxidation and formation of Fe₂O₃, which may be in hydroxide form —Fe₂O₃.xH₂O and/or Fe(OH)₃, and perhaps other species of ferric oxide depending on the conditions. These oxides and hydroxides are in solid or colloidal form, generally from 0.5 to 1.5 micron in size and are filtered out by a filter 33 capable of removing such materials. Where chloride oxidizing agents are used, the precipitates may be somewhat larger.

Line 34 passes from exhaust port 18 (FIGS. 1a and 1b) of the cavitation device to filter 33. Filter 33 is desirably a nanofiber medium of Nylon 66 or materials having similar properties, and desirably such a filter medium made and sold by DuPont under the trademark HMT. The filter may be operated in the dead-end or cross-flow mode. For cross-flow, a beneficial filter medium is a sintered 904 stainless steel metallic membrane or a sintered ceramic membrane; porous plastic filters having a membrane coating of an appropriate pore size may also be used. Membrane and other filters able to remove particles of size 0.5 are readily available commercially.

We may use any filter capable of removing particles as small as one micron and preferably as small as 0.5 micron. The retentate in filter 33 may be disposed of in any convenient manner; desirably the filter will be capable of convenient cleaning or backwashing for reuse, but disposable filters are also contemplated. Permeate of greatly reduced iron content passing through filter 33 is taken in line 29 to a holding tank for reuse or recirculation as a workover or completion fluid, or can be sent directly to such use. Where it has been established that the solids include substantial portions of somewhat larger floc, the filtration step may include a screen or first filter of larger pore size upstream of the filter 33.

Optionally, the system also utilizes flash tank 36. Flash tank 36 is used to enhance the removal of water from the treated fluid in a manner similar to that shown and described by Smith and Sloan in U.S. Pat. No. 7,201,225. As shown in the '225 patent, upper outlet 39 from flash tank 36 contains vapor or steam which may be vented or condensed to make clean water for use elsewhere; its removal may be enhanced by an applied vacuum. Removal of water from the input solution in conduit 31 means that less fluid must be handled by the filters. This somewhat concentrated fluid 37 is supplied through line 34b from flash tank 36 to filter 33. Liquid in line 34 can be sent entirely to the flash tank 36 through line 34a, or directly to the filters, or partially to each, within the discretion of the operator. If the flash tank 36 is used, oxygen from the air will be entrained in the somewhat concentrated fluid 37 in the bottom of the flash tank, and this fluid 37 may be recycled to the cavitation device through line 38, thus providing more oxygen for use in oxidizing the iron in the liquid while also providing another opportunity for oxidation of any yet unoxidized iron. In some situations, the flash tank may be used as the source of all the oxygen in the system.

The system of FIG. 2 is provided with recycle capabilities as well as pH-adjusting capabilities. The pH is generally beneficially increased by introducing a base through line 35, so that it will be intimately mixed along with the oxidizing agent. As is known in the art, a pH higher than about 2.5 is necessary for ferrous oxide to achieve a colloidal, filterable state. Accordingly, where the pH is lower than 2.5, addition of a pH-increasing agent is recommended.

An improvement in the present invention is the introduction of calcium oxide (lime) through line 35 to the incoming fluid in line 31. The lime will be thoroughly mixed in the cavitation device 30 along with the oxygenating agent added in line 32, enhancing the formation of iron-containing solids for separation. The lime may be added in substitution for the pH-increasing base or as a supplement to it.

We maintain the temperatures within the cavitation device at least 42° C. and generally 60° C. or higher. Maintenance of the temperature, and consequent enhancement of the oxidation reaction, is benefited by a significant percentage of recycling through the cavitation device. Recycle line 28 accordingly returns a portion of the liquid in line 34 to conduit 31 for reintroduction to cavitation device 30. Although in many situations recycling may not be necessary, the process may benefit from recycling as little as 10% of the fluid in line 34 and as much as 90%. Specifications of the cavitation device should be reconsidered when recycling a very large volume of fluid is contemplated.

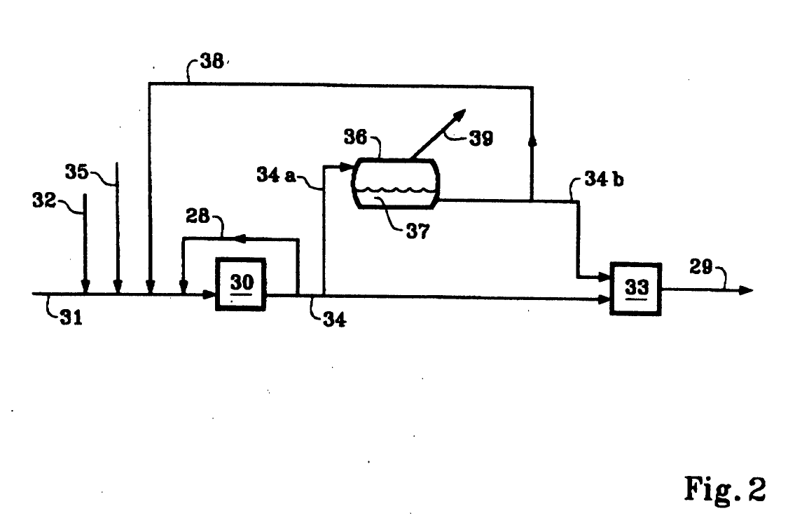

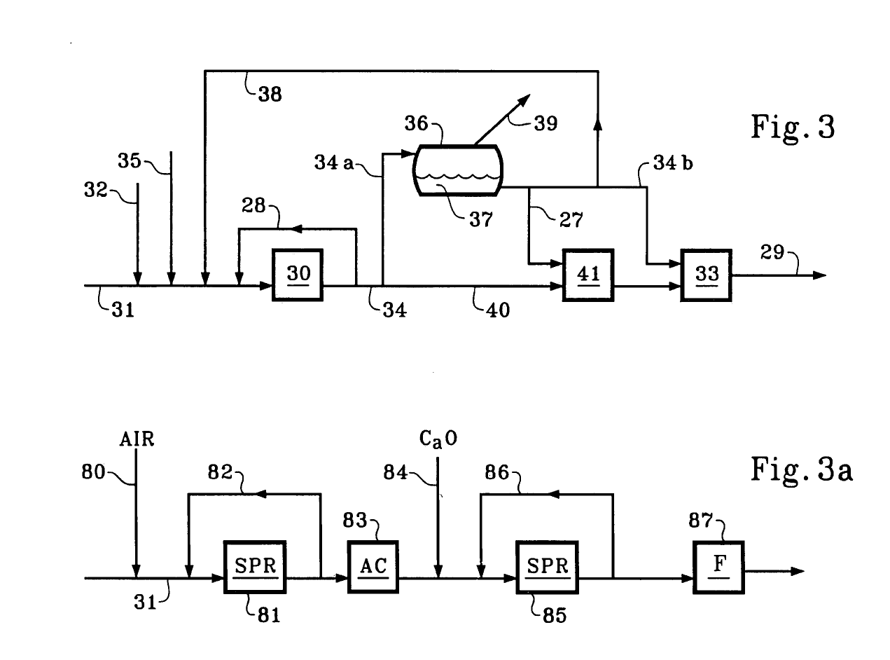

FIG. 3, in many respects similar to FIG. 2, is a flow sheet illustrating the use of activated carbon to enhance the oxidation reaction. An alternate line 40 carries the output liquid from an exhaust port 18 (FIG. 1a or 1b) of cavitation device 30 directly to a container 41 for a bed of activated carbon capable of enhancing the oxidation of the iron species present in the liquid by an oxidizing agent in the liquid.

A catalytic activated carbon made by Calgon Carbon Corporation and sold under the trademark CENTAUR has been found satisfactory. See U.S. Pat. No. 5,356,849, which explains that activated carbon made in a certain way will accelerate the decomposition of hydrogen peroxide, thus making the reactive oxygen more readily available for reaction with ferrous iron. See also Hayden U.S. Pat. No. 5,637,232 and the prior art reviewed in relating to catalytic oxidation by activated carbon. It is recommended that the operator review the specifications of the activated carbon with respect to the particulars of the type of oxidizing agent used. The activated carbon container 41 may also (or alternatively) be fed by line 27 from the flash tank 36, which has the advantage that less liquid must be handled by the activated carbon than otherwise would be the case, since fluid 37 is somewhat concentrated; also some of the solids will have settled in flash tank 36 and accordingly the activated carbon bed will be less likely to be fouled by solids. After passing through the activated carbon bed in container 41, where additional colloidal iron is created, the liquid is passed through line 43 to the filter 33, similar to the filter 33 in FIG. 2.

Referring now to FIG. 3a, a variation is shown in which the oxidizing agent (air, in this case) is introduced for treatment by a first cavitation device and the calcium oxide is introduced for treatment by a second cavitation device. Fluid in line 31 first receives air (as an example of oxidizing agent) from line 80. The air is mixed with the fluid in the cavitation device 81, which may have an optional recycle line 82 and may send some of its output to a flash tank as illustrated in FIGS. 2 and 3. After the air is intimately mixed with the fluid in the cavitation device, it may be sent to an optional activated carbon unit 83, which catalyzes the oxidation reaction as explained elsewhere herein. Because of the intimate mixing and heat imparted by the cavitaion device 81, the catalyzed oxidation reaction is enhanced, and iron is converted to higher oxidation states. Lime is then added from line 84 and the fluid is taken to a second cavitation device 85, where the calcium oxide is intimately mixed with the oxidized iron species, forming complex insolubles as explained elsewhere herein. Again, the cavitation device may have a recycle line 86 and again it may send at least some of its output to a flash tank configured as in FIGS. 2 and 3. Recycle line 86 can also be configured to recycle a portion of the output of cavitation device 85 to line 31 for input to cavitation device 81. It should be noted that the fluid generally will be higher in temperature in cavitation device 85 than in cavitation device 81 simply because it is downstream of cavitation device 81 and thus conducive to more efficient removal of water as steam or vapor. After treatment in the second cavitation device 85, the fluid is sent to a filter section 87, which again may comprise one or more filters.

It should be understood that the oxidation of ferrous iron and its partially oxidized forms found in used workover, drilling or completion fluids, produced and flowback fluids normally requires not only simple but intimate contact with an oxidizing agent, but a facilitating temperature and a residence time sufficient to bring about oxidation in practical amounts. We are able to greatly accelerate the oxidation of iron in its lower oxidation states by breaking up the air into minute bubbles, thus greatly increasing their surface area for a given volume of air, at the same time elevating the temperature of the fluid being treated, which enhances the oxidation reaction. Efficient removal of the colloids and solids formed in the oxidation process is enhanced by the addition of lime. That is, the lime does not merely increase the pH, which in itself favors the oxidation reaction, but it also tends to from a floc with the colloids and solid products of the oxidation reactions such as Fe(OH)₃. Again, any amount of calcium oxide will have a commensurately beneficial result, but it may also be emphasized that the cavitation device is able to handle high concentrations of solids. We may use any combination of amounts of air or other oxidizing agent and calcium oxide which is effective to separate at least some iron, in any form, from the fluid under the conditions obtained within the cavitaion device.

### EXAMPLE

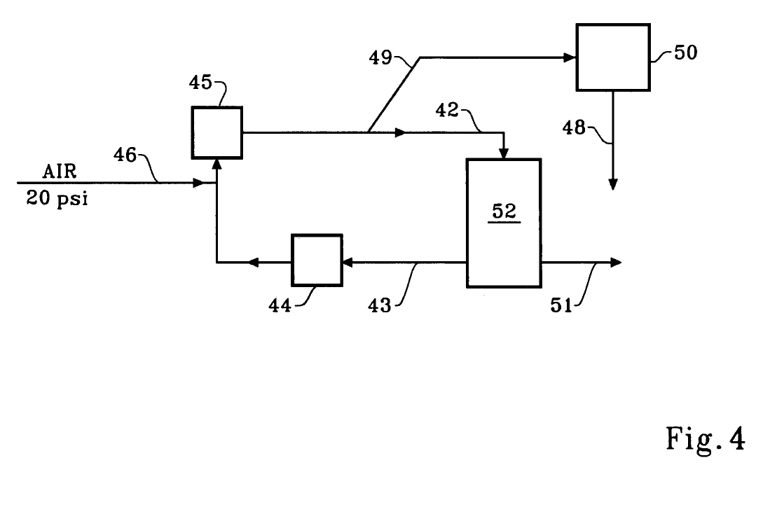

please refer to FIG. 4.

Five gallons of a used oilfield brine having a density of 19.8 ppg (pounds per gallon), including a high concentration of zinc bromide and 700 ppm (parts per million) soluble Fe were placed in a small tank 52. The tank was fitted with an inlet tube 42 and an outlet conduit 43. Outlet conduit 43 leads to a pump 44, which sent the brine to the cavitation device 45. A compressed air source supplied a substantially constant stream of air at a pressure of 20 psi (pounds per square inch) into the cavitation device, introduced to the brine through compressed air line 46 before it was subjected to the mixing effect of cavitation device 45. Calcium oxide was added directly to the tank 52 but can be added to the brine in outlet conduit 43 alternatively. In the cavitation device 45, the brine, air, and calcium oxide were intimately mixed while the temperature was elevated somewhat; the mixture, now including oxidation reaction products, was sent from the cavitation device to inlet tube 42. In this example, the brine mixture was continuously circulated through the pump 44, cavitation device 45, and tank 52 as shown in the following time chart:

| | | | | | Lime |
|---|---|---|---|---|---|
| | | Inlet | Outlet | | added |
| Time | SPR (Hz/rpm) | (° F.) | (° F.) | Fe (ppm) | (grams) |
| 7:25 | 20/1200 | 79.4 | 80.8 | 700 | |
| 8:00 | 20/1200 | 96.1 | 96.7 | | 111 |
| 8:15 | 20/1200 | 100.4 | 101.7 | | 103 |
| 8:30 | 20/1200 | 105.8 | 107.2 | | 108 |
| 8:45 | 20/1200 | 110.1 | 111.4 | | 131 |
| 9:00 | 20/1200 | 113.9 | 115.2 | 350 | |
| 9:30 | 20/1200 | 113.9 | 115.3 | | |
| 10:00 | 20/1200 | 114.1 | 115.5 | 200 | |
| 10:30 | 20/1200 | 114.7 | 116.3 | | |
| 11:00 | 20/1200 | 116.0 | 117.3 | 90 | |
| 11:30 | 20/1200 | 116.5 | 117.9 | | |
| 13:00 | 20/1200 | 108.7 | 109.4 | 30 | |
| 13:30 | 20/1200 | 107.3 | 108.8 | | |
| 14:00 | 20/1200 | 112.8 | 114.4 | 15 | |

The iron content of the fluid was measured in fluid samples taken from the outlet conduit 43. Turbidity and floc particles were observed to form in the fluid. Although a small portion of the solids settled in the bottom of tank 52, the solids were largely suspended in the fluid, which may have been at least partly due to the very high density of the brine. Increasing turbidity and floc formation were visually observed throughout the experiment. The solids were believed to be a complex composition comprising iron in a higher oxidation state, oxygen and calcium. It may be observed that the outlet temperature of the fluid remained substantially steady after the last addition of lime, in the range of 115.2° F. to 117.9° F. for a period of two and a half hours while the iron content of the fluid steadily decreased.

Referring again to FIG. 4, although there was no filtration performed in the experiment of Example 1, a line 49 is seen leading from tube 42 to a filter 50 which may be used to remove the solids created by the oxidation and other reactions that are facilitated by the mixing and heating in the cavitation device 45, resulting in a filtered, reduced-iron brine in line 48, which may be reused immediately, adjusted for reuse, or saved for a different project. Alternatively, solids-containing fluid can be fed from the tank 52 through line 51 to a different filter or to filter 50. While many types of filters can be used, it should be kept in mind that a colloidal form of iron oxide may require a filter having a pore size of 0.5 micron as indicated above.

The experiment of Example 1 demonstrated that the cavitation device can be used to rapidly facilitate the oxidation of iron and formation of filterable materials when both air and lime are introduced. We do not require that the fluid be recirculated, however, since the cavitation device is capable of elevating the temperature considerably above the temperatures attained in Example 1, and/or achieving even better mixing than appears to be the case in this experiment. The particular cavitation device was held to 1200 rpm although it is capable of as much as 5000 rpm and such high energy input may be used in our invention when it is practiced on site in the field.

FIG. 5 is adapted from FIG. 1 of Hudson U.S. Pat. No. 6,627,784, one of the patents incorporated in its entirety by reference. FIG. 5 shows a cavitation device differing slightly from the cavitation device of FIGS. 1a and 1b. In FIG. 5, a used brine containing added calcium oxide, for example, in conduit 60, perhaps coming from a pump placed as pump 44 in FIG. 4, is mixed with air, from conduit 61, similar to the compressed air in compressed air line 46 of FIG. 4. The air immediately becomes dispersed in the form of bubbles 62 in conduit 63, which is split in two parts to enter the cavitation device at opposite sides of the rotor 64, mounted on shaft 70. As illustrated for the similar cavitation device in FIGS. 1a and 1b, the calcium oxide containing brine, now mixed with air, enters clearance 65 and becomes subjected to the cavitation action imparted by passage of the brine between rotating rotor 64, containing cavities 68, and housing 66. The air is immediately broken into small bubbles which are further broken down and formed into evenly dispersed microbubbles in the brine 69. The intimate mixing and elevated temperatures enhance the oxidation of iron present in the brine by the oxygen of the air, forming a solid or colloid containing iron oxide, which then tends to join the calcium oxide to form somewhat larger solids before leaving through conduit 67.

It is seen, therefore, that our invention comprises a method of treating a used oilfield fluid containing iron to remove iron therefrom comprising (a) passing the used oilfield fluid through a cavitation device in the presence of added oxygen, thereby mixing the oxygen with the oilfield fluid, elevating the temperature of the oilfield fluid and forming iron oxide solids therein, and (b) passing the used oilfield fluid through a filter capable of removing the iron oxide solids.

It also includes a method of treating an oilfield drilling, workover or completion fluid to remove iron therefrom comprising adding an oxidizing agent to the fluid and passing the fluid through a bed of activated carbon capable of enhancing the oxidation of ferrous iron.

In addition, our invention includes a method of removing iron from a used oilfield fluid containing iron comprising (1) passing the fluid through a cavitation device in the presence of an oxidizing agent (2) controlling the operation of the cavitation device to maintain it effective to (a) elevate the temperature, (b) dissolve and mix the oxidizing agent with the fluid, and (c) achieve the reaction of the oxidizing agent and the iron to form insoluble iron oxide, and (3) separating the insoluble iron oxide from the fluid in a filter.

Any of the methods summarized in the above three paragraphs may be modified by the addition of calcium oxide to the fluid as described herein and in the following claims:

1-20. (canceled)

21. Method of treating a used oilfield fluid containing iron to remove iron therefrom comprising (a) passing said used oilfield fluid through a cavitation device in the presence of added oxygen and calcium oxide, thereby mixing said oxygen and said calcium oxide with said oilfield fluid, elevating the temperature of said oilfield fluid, and forming iron oxide solids therein, and (b) passing said used oilfield fluid through a filter capable of removing said iron oxide solids.

22. Method of claim 21 including recycling at least a portion of said used oilfield fluid from the outlet of said cavitation device to the inlet thereof.

23. Method of claim 21 including (c) passing at least a portion of said used oilfield fluid from said cavitation device to a flash tank, and (d) recycling at least a portion of said used oilfield fluid from said flash tank to said cavitation device, wherein oxygen is incorporated into said used oilfield fluid in said flash tank from the atmosphere therein

24. Method of claim 21 wherein at least a portion of said oxygen is added in the form of air.

25. Method of claim 21 including, prior to step (b), passing said fluid with said added oxygen through a bed of activated carbon capable of catalyzing an iron oxidation reaction in said fluid.

26. Method of claim 21 wherein said filter is capable of removing particles as small as 0.5 micron.

27. Method of claim 21 including maintaining temperatures of at least 60° C. within said cavitation device.

28. Method of claim 21 including maintaining a pH of at least 2.5 within said cavitation device.

29. Method of claim 24 wherein said air enters said fluid at a pressure of at least 20 pounds per square inch.

30. Method of claim 21 wherein said filter is a crossflow filter.

31. Method of claim 21 wherein said used oilfield fluid also contains a viscosity-enhancing polymer, and including impairing the viscosity-enhancing effect of said polymer in said cavitation device.

32. Method of claim 22 wherein about 10% to about 90% of said fluid is substantially continuously recycled from the outlet of said cavitation device to its inlet.

33. Method of claim 21 including passing said fluid from said cavitation device to a flash tank, evaporating at least some water from said fluid to achieve a fluid of less volume, and passing said fluid of less volume to a filter capable of removing particles as small as 1 micron.

34. Method of claim 21 which is substantially continuous and wherein the concentration of oxygen in said fluid is maintained at 2 mg/L or greater.

35. Method of treating a used oilfield fluid to remove iron therefrom comprising (a) adding an oxidizing agent to said fluid, (b) passing said fluid through a first cavitation device to mix said oxidizing agent and said fluid, (c) adding calcium oxide to said fluid, (d) passing said fluid through a second cavitation device to mix and heat said fluid, and thereafter (e) filtering said fluid.

36. Method of claim 35 including, between step (b) and step (c), passing said fluid through a bed of activated carbon capable of enhancing the oxidation of ferrous iron.

37. Method of removing iron from a used oilfield fluid containing iron comprising (1) passing said fluid through a cavitation device in the presence of an oxidizing agent and calcium oxide, (2) controlling the operation of said cavitation device to maintain it effective to (a) elevate the temperature, (b) dissolve and mix said oxygen with said fluid, and (c) achieve the reaction of said oxidizing agent and said iron to form insoluble iron oxide, and (3) separating said insoluble iron oxide from said fluid in a filter.

38. Method of claim 37 wherein said filter is capable of removing particles of 0.5 micron.

39. Method of claim 37 including recycling at least a portion of said fluid through said cavitation device.

40. Method of claim 37 wherein said temperature is elevated to at least 40° C.
